(19) United States
(12) Patent Application Publication
(10) Pub. No.: US 2013/0200772 A1
(43) Pub. Date: Aug. 8, 2013

(54) Closure element

(71) Applicant: LIEBHERR-HAUSGERATE LIENZ GMBH, Lienz (AT)

(72) Inventors: Mohd Kamal MAHAT, Kluang (MY); Lip Keong KWAK, Klang (MY); Muhd Shuhail HASSAN, Kluang (MY); M. Noorashidi M. NASIR, Kluang (MY)

(73) Assignee: LIEBHERR-HAUSGERATE LIENZ GMBH, Lienz (AT)

(21) Appl. No.: 13/747,990

(22) Filed: Jan. 23, 2013

(30) Foreign Application Priority Data
Jan. 25, 2012 (DE) 102012001319.1
Feb. 15, 2012 (DE) 102012003003.7

(51) Int. Cl. E06B 7/36; F25D 23/02

(52) U.S. Cl. CPC E06B 7/36; F25D 23/028
USPC 312/405; 49/414

(57) ABSTRACT

The present invention relates to a closure element for a chest refrigerator and/or chest freezer, wherein the closure element has at least one first sliding cover and wherein at least one limiting means is provided which limits the path by which the first sliding cover is displaceable. In accordance with the invention, the limiting means is arranged on the lower side of the sliding cover.

The present invention relates to a closure element for a chest refrigerator and/or chest freezer or a closure element of a chest refrigerator and/or chest freezer, wherein the closure element has at least one sliding cover and wherein at least one limiting means is provided which limits the path by which the first sliding cover can be displaced.

It is known from the prior art to provide a trap protection in chest refrigerators and/or chest freezers which prevents the trapping of fingers on the movement of a sliding cover. These limiting means are arranged on the upper side of the glass frame and thus disturb the visual appearance of the closure element or of the chest refrigerator and/or chest freezer.

It is thus the underlying object of the present invention to further develop a closure element of the initially named kind such that it provides a visually appealing impression without restrictions in functionality.

This object is achieved by a closure element having the features of claim 1. Provision is accordingly made that the limiting means is arranged on the lower side of the sliding cover.

Provision is made in a preferred embodiment of the invention that the closure element has at least one second cover which can likewise be designed as a sliding cover and that the limiting means is arranged such that it abuts the second cover in an end position of the movement of the first sliding cover.

In this manner, the probability of the accidental trapping of fingers on or at the first sliding cover preferably designed as a sliding glass cover is reduced if both sliding covers or if the first sliding cover are/is in their/its open position or are/is moved into it.

If the first sliding cover is moved from its closed position into its open position, the limiting means, for example, abuts the end-side edge, i.e. the edge extending transversely to the direction of movement of the first sliding cover, of the second cover or of the second sliding cover which can be in its closed position, whereby the further movement of the first sliding cover is prevented. It is precluded in this manner that fingers can be trapped between the two covers or between the first sliding cover and a carcass section of the chest refrigerator and/or freezer refrigerator by the movement of the first sliding cover.

Provision is made in a further embodiment of the invention that the first sliding cover and/or the second cover has/have a preferably peripheral frame which respectively surrounds a pane, preferably a pane of glass or plastic.

Provision is made in a further aspect of the invention that the frame comprises a plurality of frame parts which are connected to one another by the process of ultrasound welding. It is conceivable in this respect that the two frame parts connected in this manner are configured such that one of the frame parts has a projection and the other one of the frame parts has a receiver into which the projection is introduced. During the course of manufacture of the sliding cover, the two frame parts are first placed together and then connected by ultrasound welding.

Provision is made in a further embodiment of the invention that the limiting means is configured as a projection which extends downwardly from the lower side of the first sliding cover.

The first sliding cover can have an end-side end region and the limiting means can be spaced apart from this end-side end region. In this case, the movement path of the first sliding cover is smaller than its length in the direction of movement since the limiting means prevents the further movement of the first sliding cover as soon as it, for example, abuts the second cover or also at another site, e.g. at a component of the carcass.

Provision is made in a further embodiment of the invention that the first sliding cover has a length extending in its sliding direction as well as an end-side edge at which the first sliding cover is in contact with the carcass of a chest refrigerator and/or chest freezer in the closed state and that the named limiting means is arranged in a section of the sliding cover which extends by up to, preferably by up to ¼ of the length of the first sliding cover from its end-side edge.

Provision is made in a further embodiment of the invention that the limiting means is configured in one piece with the first sliding cover. It is conceivable to configure the first sliding cover or its frame from plastic and to configure the limiting means in one piece with this frame.

It is, however, also conceivable that the limiting means is configured as a separate part which is connected to the first sliding cover in a suitable manner, for example by a screw connection.

Provision is made in a further embodiment of the invention that the limiting means is arranged in one or both of the marginal regions of the first sliding cover or extends over the total width of the first sliding cover.

A visually appealing overall impression of the chest refrigerator and/or chest freezer is achieved by the arrangement of the at least one limiting means on the lower side of the first sliding cover since the limiting means is not visible, or is not easily visible, from the outside and is much less obtrusive than a limiting means arranged on the upper side of the sliding cover.

The limiting means can furthermore be arranged such that it reduces the gap between the first sliding cover and the cover, whereby the heat input from outside through the closure element or between the covers into the cooled inner space is correspondingly prevented or reduced.

The present invention furthermore relates to a chest refrigerator and/or chest freezer having a carcass and having at least one closure element by which the open side of the carcass can be closed, wherein the closure element is configured in accordance with one of the claims 1 to 8.

Provision is preferably made that the chest refrigerator and/or the chest freezer has a guide frame in the upper end region of the carcass in which the first sliding cover or the first sliding cover and the second cover is/are displaceably received. An embodiment is thus covered by the invention in which only the first sliding cover is movable and the second cover is fixed as well as also a preferred embodiment in which both the first sliding cover and the second cover are arranged displaceably.

Further details and advantages of the invention will be explained in more detail with reference to an embodiment shown in the drawing. There are shown:

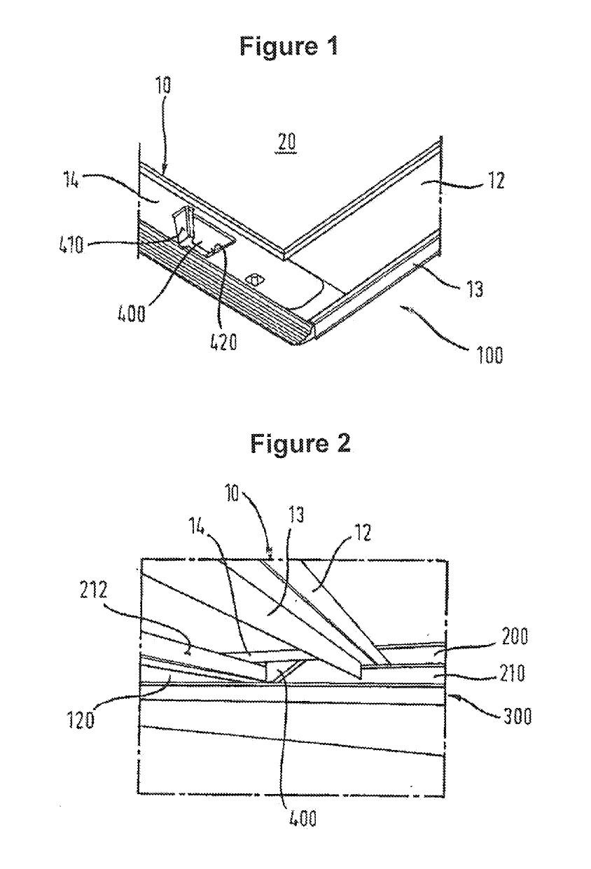

FIG. 1: a perspective view of the first sliding cover in a view obliquely from below; and

FIG. 2: a perspective view of both sliding covers, with the first sliding cover being in the open position.

A corner region of a first sliding cover 100 of a chest refrigerator and/or chest freezer is shown in FIG. 1. This first sliding cover 100 includes a frame 10 which is designed as peripheral and which surrounds a glass pane 20.

The frame 10 has two end-side elements 12 which extend transversely to the direction of movement of the first sliding cover 100 and two frame parts 14 extending in the longitudinal direction, which extend in the direction of movement of the frame 10 and which run perpendicular to the end-side frame elements 12.

As can furthermore be seen from FIG. 1, a sealing lip 13 is located at a marginal region of one of the end-side frame elements 12. This has the function of effecting a seal with respect to the carcass in the closed state of the first sliding cover.

As can be seen from FIG. 2, the first sliding cover 100 is connected at its two lateral frame parts 14 or at their marginal regions to a guide 200 such that the first sliding cover 100 is displaceable along the guides 200. In this respect, the outwardly facing edges of the frame elements 14 extending in the longitudinal direction are received in the named guides 200 which are received oppositely disposed and in parallel with one another at a guide frame 300 of the appliance carcass. The guide frame forms the upper termination of the chest refrigerator and/or chest freezer.

A second guide 210 for a second sliding cover 120 is located beneath the guide 200 for the first sliding cover 100.

This second sliding cover 120 thus runs in a guide 210 which is arranged beneath the guide 200 and extends parallel therewith. This embodiment thus allows a displacement of the two sliding covers 100, 120 in the respective guides 200, 210.

As can be seen from FIG. 1 and also from FIG. 2, a limiting means 400, which is designed as a downwardly directed projection, extends from the lower side of the frame element 14 of the first sliding cover 100 extending in the longitudinal direction. This limiting means 400 has an oblique flank 420 as well as a vertically standing flank, with the vertically standing flank 410 serving as an abutment element, as can be seen from FIG. 2.

If the first sliding covet 200 is moved to the left from its closed position in accordance with FIG. 2, a coming together of the limiting means 400 or of its edge 410 standing perpendicular with the end-face edge 212 of the second sliding cover 210 takes place in a specific position of the first sliding cover 200. This has the consequence that the first sliding cover 200 cannot be moved further to the left beyond the position shown in FIG. 2. A trapping of fingers between the carcass or the guide frame and the first sliding cover 200 or between the two sliding covers 200, 210 or their panes, preferably glass panes, is thus prevented.

The limiting means 400 shown in FIGS. 1 and 2 can extend in one of the frame elements extending in the longitudinal direction or also in both frame elements 14 arranged in parallel. It is also conceivable that the limiting means 400 does not only extend in the region beneath these frame element 14, but rather extends transversely over the width of the first sliding cover 200 and thus also extends between the two frame elements extending 14 in the longitudinal direction.

Provision is made in a preferred embodiment of the invention that the frame 10 is made up of a plurality of individual frame elements 12, 14 which are connected to one another by ultrasound welding, it is preferred in this respect if the two frame elements 12, 14 are first held together by shape matching and are subsequently fixed relative to one another by an ultrasound weld connection. It is possible in this respect that a frame element has a projection, such as a tab, for example, which is introduced into a mount of the other frame element and latches there, for example, in order to be held in a shape-matched manner in this way. A reliable and long-term connection between the two frame elements 12, 14 can then be established by an ultrasound weld connection.

1. A closure element for a chest refrigerator and/or a chest freezer or a closure element of a chest refrigerator and/or chest freezer, wherein the closure element has at least one first sliding cover and wherein at least one limiting means is provided which limits the path by which the first sliding cover is displaceable, wherein the limiting means is arranged on the lower side of the sliding cover.

2. A closure element in accordance with claim 1, wherein the closure element has at least one second cover, and the limiting means is arranged such that it abuts the second cover in an end position of the movement of the first sliding cover.

3. A closure element in accordance with claim 1, wherein the first sliding cover has a peripheral frame which surrounds at least one pane.

4. A closure element in accordance with claim 1, wherein the limiting means is configured as a projection which extends downwardly from the lower side of the first sliding cover.

5. A closure element in accordance with claim 1, wherein the first sliding cover has an end-side end region which extends transversely to the direction of movement of the first sliding cover; and the limiting means is spaced apart from this end-side end region.

6. A closure element in accordance with claim 1, wherein the limiting means is configured in one piece with the first sliding cover or is formed by a separate part which is connected to the first sliding cover; and/or the limiting means is arranged in one or both marginal regions of the first sliding cover or extends over the total width of the first sliding cover.

7. A closure element in accordance with claim 2, wherein the first sliding cover and/or the second cover has/have at least one frame of a plurality of frame parts, wherein provision is made that of two frame parts adjacent in the frame one has a projection and the other has a mount into which the projection is introduced and wherein the two named frame parts are connected to one another by an ultrasound weld.

8. A chest refrigerator and/or chest freezer having a carcass and having a closure element by which the open side of the carcass can be closed, wherein the closure element is configured in accordance with claim 1.

9. A chest refrigerator and/or chest freezer in accordance with claim 8, wherein the chest has a guide frame in an upper end region of the carcass in which the first sliding cover or the first sliding cover and the second cover is/are displaceably received.

10. A closure element in accordance with claim 2, wherein the second cover is a sliding cover.

11. A closure element in accordance with claim 2, wherein the second cover has a peripheral frame which respectively surrounds at least one pane.

12. A closure element in accordance with claim 11, wherein the pane is a glass pane or a plastic pane
